(19) United States
(12) Patent Application Publication
(10) Pub. No.: US 2019/0035585 A1
(43) Pub. Date: Jan. 31, 2019

(54) ELECTROMAGNETIC RELAY

(71) Applicant: OMRON Corporation, Kyoto (JP)

(72) Inventors: Ryota Minowa, Kumamoto (JP); Shingo Mori, Kumamoto (JP)

(73) Assignee: OMRON Corporation, Kyoto (JP)

(21) Appl. No.: 16/085,874

(22) PCT Filed: Feb. 14, 2017
(86) PCT No.: PCT/JP2017/005369

§ 371 Date: Sep. 17, 2018

(30) Foreign Application Priority Data
Apr. 22, 2016 (JP) 2016-086449

(51) Int. Cl. H01H 50/54; H01H 50/42; H01H 50/38; H01H 51/29

(52) U.S. Cl. CPC H01H 50/54; H01H 50/42; H01H 50/44; H01H 51/29; H01H 2203/056; H01H 50/38

(57) ABSTRACT

An electromagnetic relay includes a pair of fixed contacts, a pair of movable contacts that respectively face the pair of fixed contacts and are structured to respectively come into contact with and be separated from the pair of fixed contacts, a movable touch piece configured to electrically connect the pair of movable contacts, and a pair of permanent magnets that are arranged on a straight line passing through the pair of fixed contacts and the pair of movable contacts in a planar view seen along a contact-separation direction in which each of the movable contacts comes into contact with or is separated from each of the fixed contacts. The pair of permanent magnets face each other. The pair of permanent magnets are arranged so as to sandwich the pair of fixed contacts and the pair of movable contacts.

### BACKGROUND

### Technical Field

The present invention relates to an electromagnetic relay.

### Related Art

The electromagnetic relay disclosed in Patent Document 1 includes a pair of fixed contacts, a pair of movable contacts that respectively come into contact with or are separated from the pair of fixed contacts, and a movable touch piece that couples the pair of movable contacts. An auxiliary yoke is provided between the pair of fixed contacts and the pair of movable contacts.

In the electromagnetic relay, an electromagnetic repulsive force is canceled out by the attraction force of the auxiliary yoke to ensure the contact reliability between the fixed contact and the movable contact, the electromagnetic repulsive force being generated when a current flows by conduction between the fixed contact and the movable contact.

### PATENT DOCUMENT

Patent Document 1: Japanese Patent No. 5559662

### SUMMARY OF THE INVENTION

One or more embodiments of the present invention is capable of ensuring the contact reliability between contacts, which is not disclosed in conventional relays including Patent Document 1.

One or more embodiments of the present invention provides an electromagnetic relay capable of ensuring the contact reliability between contacts.

An electromagnetic relay according to one or more embodiments of the present invention includes: a pair of fixed contacts; a pair of movable contacts that respectively face the pair of fixed contacts and are arranged so as to be able to respectively come into contact with and be separated from the pair of fixed contacts; a movable touch piece configured to electrically connect the pair of movable contacts; and a pair of permanent magnets that are arranged on a straight line passing through the pair of fixed contacts and the pair of movable contacts in a planar view seen along a contact or separation direction in which each of the movable contacts comes into contact with or is separated from each of the fixed contacts, face each other, and are arranged so as to sandwich the pair of fixed contacts and the pair of movable contacts. A maximum distance between the pair of movable contacts in a first direction parallel to the straight line is smaller than a maximum distance between the pair of fixed contacts in the first direction in the planar view seen along the contact or separation direction.

According to an electromagnetic relay according to one or more embodiments of the present invention, in the planar view seen along the direction in which each of the movable contacts comes into contact with or is separated from each of the fixed contacts, the maximum distance between the pair of movable contacts in the first direction is smaller than the maximum distance between the pair of fixed contacts in the first direction. As a result, the overlapping portion between the fixed contact and the movable contact in the planar view seen along the contact or separation direction becomes smaller, thereby enabling reduction in electromagnetic repulsive force which is generated when a current flows between the fixed contact and the movable contact.

### BRIEF DESCRIPTION OF THE DRAWINGS

FIG. 1 is a perspective view illustrating an electromagnetic relay according to one or more embodiments of the present invention.

FIG. 2 is a sectional view taken along line II-II of FIG. 1.

FIG. 3 is a side view illustrating a contact mechanism portion and a permanent magnet of the electromagnetic relay of FIG. 1.

FIG. 4 is a plan view of a movable touch piece of the electromagnetic relay of FIG. 1.

FIG. 5 is a schematic view illustrating a state in which a fixed contact and a movable contact of the electromagnetic relay of FIG. 1 are in contact with each other.

FIG. 6 is a schematic view for explaining attraction of an arc of the electromagnetic relay of FIG. 1.

FIG. 7 is a schematic view for explaining a first modification of the movable touch piece and the movable contact of the electromagnetic relay of FIG. 1.

FIG. 8 is a side view illustrating a second modification of the movable touch piece and the movable contact of the electromagnetic relay of FIG. 1.

FIG. 9 is a plan view of the movable touch piece of FIG. 8.

FIG. 10 is a side view illustrating a third modification of the movable touch piece and the movable contact of the electromagnetic relay of FIG. 1.

FIG. 11 is a plan view of a movable touch piece of the contact mechanism portion of FIG. 10.

FIG. 12 is a side view illustrating a fourth modification of the movable touch piece and the movable contact of the electromagnetic relay of FIG. 1.

FIG. 13 is a plan view of the movable touch piece of the contact mechanism portion of FIG. 12.

FIG. 14 is a side view illustrating a fifth modification of the movable touch piece and the movable contact of the electromagnetic relay of FIG. 1.

FIG. 15 is a plan view of the movable touch piece of the contact mechanism portion of FIG. 14.

FIG. 16 is a side view illustrating a sixth modification of the movable touch piece and the movable contact of the electromagnetic relay of FIG. 1.

FIG. 17 is a plan view of a movable touch piece of the contact mechanism portion of FIG. 15.

FIG. 18 is a side view illustrating a seventh modification of the movable touch piece and the movable contact of the electromagnetic relay of FIG. 1.

FIG. 19 is a plan view of a movable touch piece of the contact mechanism portion of FIG. 18.

FIG. 20 is a side view illustrating an eighth modification of the movable touch piece and the movable contact of the electromagnetic relay of FIG. 1.

FIG. 21 is a plan view of a movable touch piece of the contact mechanism portion of FIG. 20.

### DETAILED DESCRIPTION

Hereinafter, embodiments of the present invention will be described with reference to the accompanying drawings. In the following description, terms (e.g., terms including “upper”, “lower”, “right”, and “left”) indicating specific directions or positions are used as necessary, but the use of these terms is for facilitating understanding of the invention with reference to the drawings, and the technical scope of the present invention is not limited by the meaning of these terms. The following description is merely exemplary in nature and is not intended to limit the present invention, its application, or its usage. Further, the drawings are schematic, and ratios of dimensions do not necessarily agree with actual ones. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

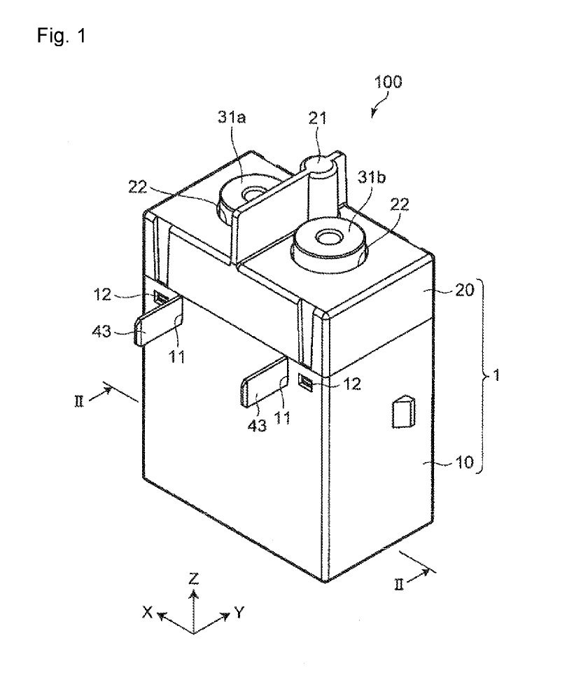

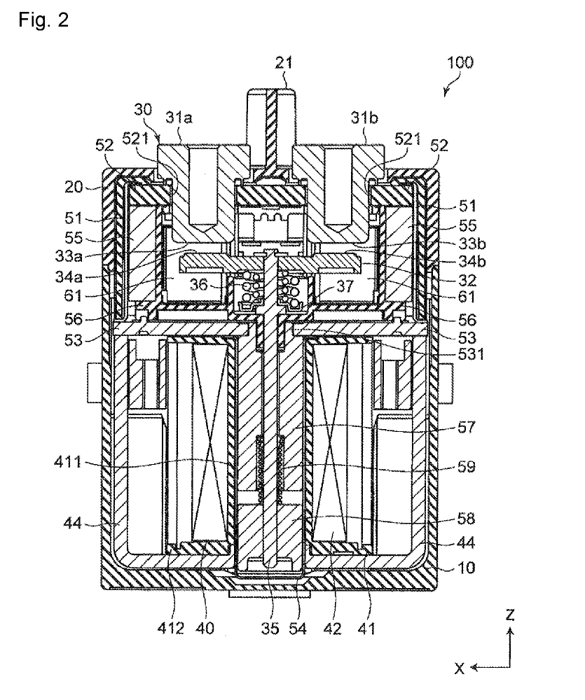

As illustrated in FIG. 1, an electromagnetic relay 100 according to one or more embodiments of the present invention includes a housing 1 made up of a case 10 and a cover 20. As illustrated in FIG. 2, a contact mechanism portion 30 and an electromagnet portion 40 that drives the contact mechanism portion 30 are accommodated inside the housing 1.

In FIG. 2, a horizontal direction is defined as an X direction, and a vertical direction is defined as a Z direction. Further, a direction orthogonal to the X and Z directions is defined as a Y direction.

As illustrated in FIG. 1, the case 10 has a rectangular box shape. As illustrated in FIG. 2, the case 10 has an opening on the upper side in the Z direction, and is formed so as to be able to accommodate on the inside a part of the contact mechanism portion 30 and an electromagnet portion 40.

As illustrated in FIG. 1, the side surface of the case 10 in the Y direction is provided with a terminal groove 11 in which the coil terminal 43 protrudes, and a latching hole 12 for fixing the case 10 and the cover 20.

As illustrated in FIG. 1, the cover 20 has a rectangular box shape and is attached so as to cover the opening of the case 10. As illustrated in FIG. 2, the cover 20 has an opening at the lower side in the Z direction, and is formed so as to be able to accommodate a part of the contact mechanism portion 30 on the inside.

The upper surface of the cover 20 in the Z direction is provided with a partition wall 21 which is provided substantially at the center in the X direction and extends in the Y direction. Terminal holes 22, in which the fixed terminals 31a, 31b protrude, are respectively provided on both sides of the partition wall 21 in the X direction. Although not illustrated, the opening of the cover 20 is provided with latching pawls for fixing the case 10 and the cover 20 together with the latching holes 12 of the case 10.

As illustrated in FIG. 2, the contact mechanism portion 30 includes a pair of fixed terminals 31a, 31b arranged at an interval along the X direction, and a movable touch piece 32 disposed so as to face the pair of fixed terminals 31a, 31b. The movable touch piece 32 is disposed so as to be able to reciprocate along the Z direction.

Each of the pair of fixed terminals 31a, 31b has a substantially cylindrical shape. A fixed contact 33a is provided on the lower end face at the lower end of the fixed terminal 31a in the Z direction, and a fixed contact 33b is provided on the lower end face at the lower end of the fixed terminal 31b in the Z direction. As illustrated in FIG. 4, each of the pair of fixed contacts 33a, 33b has a substantially circular shape in planar view seen along the Z direction.

The movable touch piece 32 is provided with a pair of movable contacts 34a, 34b and a movable shaft 35. The pair of movable contacts 34a, 34b are arranged to face the pair of fixed contacts 33a, 33b and are electrically connected to each other by the movable touch piece 32. In addition, the pair of movable contacts 34a, 34b come into contact with or are separated from the pair of fixed contacts 33a, 33b by reciprocation of the movable touch piece 32 in the Z direction. The movable shaft 35 is provided substantially at the center of the movable touch piece 32 and extends downward in the Z direction.

Note that the pair of fixed terminals 31a, 31b and the pair of movable contacts 34a, 34b are symmetrically arranged with respect to the movable shaft 35.

As illustrated in FIG. 2, a cylindrical flange 51, a ceramic plate 52, a plate-shaped first yoke 53, and a bottomed cylindrical body 54 are provided inside the housing 1. The flange 51 and the ceramic plate 52 are disposed inside the cover 20, and the first yoke 53 and the bottomed cylindrical body 54 are disposed inside the case 10.

The flange 51 has openings above and below in the Z direction.

The ceramic plate 52 is disposed so as to close the upper opening of the flange 51 in the Z direction. The ceramic plate 52 is provided with two terminal holes 521. Fixed terminals 31a, 31b are respectively inserted and brazed into the terminal holes 521.

The first yoke 53 is disposed so as to close the lower opening of the flange 51 in the Z direction. An opening 531 is provided in the center portion of the first yoke 53. The movable shaft 35 is inserted into the opening 531.

The bottomed cylindrical body 54 extends from the first yoke 53 to the bottom of the case 10 and is disposed so as to cover the opening 531 of the first yoke 53. The bottomed cylindrical body 54 accommodates on the inside the movable shaft 35, a fixed iron core 57 fixed to the first yoke 53, and a movable iron core 58 fixed to the tip (lower end in the Z direction) of the movable shaft 35. A return spring 59 is provided between the fixed iron core 57 and the movable iron core 58.

The flange 51, the ceramic plate 52, and the first yoke 53 are integrated, and the first yoke 53 and the bottomed cylindrical body 54 are joined hermetically. As a result, a sealed space is formed inside the flange 51, the ceramic plate 52, the first yoke 53, and the bottomed cylindrical body 54. The pair of fixed contacts 33a, 33b and the pair of movable contacts 34a, 34b are arranged in this sealed space.

A pair of permanent magnets 55, 55 and an arc shielding member 61 are provided in the sealed space inside the flange 51.

The pair of permanent magnets 55, 55 face each other and are arranged at both ends inside the flange 51 in the X direction so as to sandwich the pair of fixed contacts 33a, 33b and the pair of movable contacts 34a, 34b. The pair of permanent magnets 55, 55 are held by a magnet holder 56 made of an insulating material. The magnet holder 56 extends to the movable shaft 35 along the upper surface of the first yoke 53 in the Z direction. A spring tray 37 held by the movable shaft 35 and a coil spring 35 disposed between the spring tray 37 and the movable touch piece 32 are provided between the magnet holder 56 and the movable touch piece 32. A movable shaft 35 is disposed inside the coil spring 35.

The arc shielding member 61 is disposed so as to cover both sides (the back side and the front side in FIG. 2) of the pair of fixed contacts 33a, 33b and the pair of movable contacts 34a, 34b in the Y direction and the outside (the sides closer to the adjacent permanent magnets 55) thereof in the X direction. A space 611 (illustrated in FIG. 7) for causing the magnetic flux of the permanent magnet 55 to pass therethrough is formed outside the arc shielding member 61 in the X direction.

As illustrated in FIG. 2, the electromagnet portion 40 is made up of a spool 41, a coil 42 wound around the spool 41, and a coil terminal 43 (illustrated in FIG. 1) fixed to the spool 41.

The spool 41 includes a body portion 411 in which the bottomed cylindrical body 54 is disposed, and guard portions 412 provided on both ends of the body portion 411. The spool 41 is disposed so as to be in contact with the lower surface of the first yoke 53 in the Z direction. The coil 42 is wound around the body portion 411, and the coil terminal 43 is fixed to the upper guard portion 412 in the Z direction. Note that the coil 42 is directly wound around the coil terminal 43 without interposing a lead wire.

Inside the housing 1, a second yoke 44 having a substantially U-shaped in cross section is provided. The second yoke 44 is connected to the first yoke 53 and disposed inside the case 10 so as to surround the electromagnet portion 40 together with the first yoke 53.

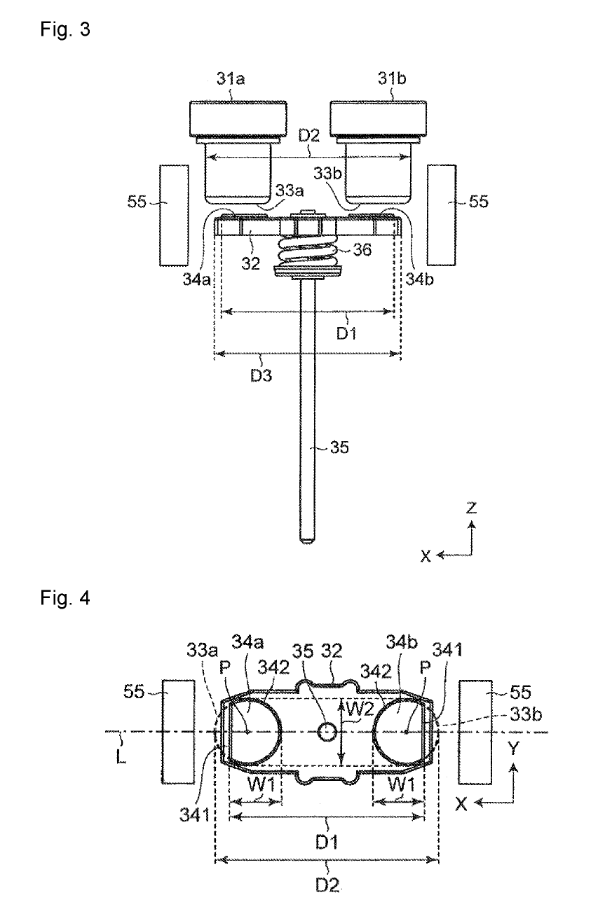

Next, the fixed contacts 33a, 33b and the movable contacts 34a, 34b will be described in detail with reference to FIGS. 3 to 5.

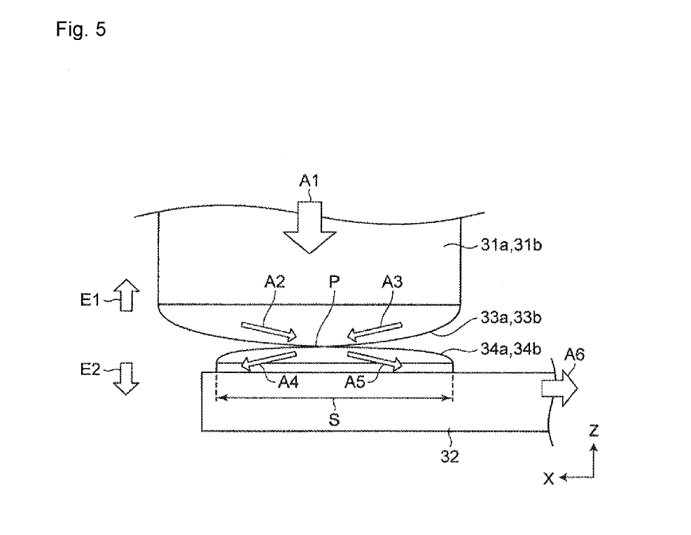

As illustrated in FIG. 3, the fixed contacts 33a, 33b are chamfered at the peripheral edges thereof, and the surfaces facing the movable contacts 34a, 34b are reduced in size. As illustrated in FIG. 5, the surfaces of the fixed contacts 33a, 33b slightly bulge toward the movable contacts 34a, 34b, and the centers thereof are contact points P which come into contact with the movable contacts 34a, 34b.

As illustrated in FIG. 4, in the planar view seen along the Z direction (a contact or separation direction in which the movable contacts 34a, 34b come into contact with or are separated), the movable contacts 34a, 34b are arranged symmetrically with respect to the movable shaft 35 so as to be located in the fixed contacts 33a, 33b and has a shape formed of a linear portion 341 and an arcuate portion 342.

The linear portion 341 extends in the Y direction and faces the adjacent permanent magnet 55. The arcuate portion 342 extends from the linear portion 341 toward the movable shaft 35. The surfaces of the movable contacts 34a, 34b slightly bulge toward the fixed contacts 33a, 33b, and the center of the circle having the arcuate portion 342 as a part is the contact point P that comes into contact with the fixed contacts 33a, 33b. The movable shaft 35 and the pair of permanent magnets 55, 55 are arranged on a straight line L connecting the contact points P of the movable contacts 34a, 34b.

That is, in the planar view seen along the Z direction (contact or separation direction), a length W1 of each of the movable contacts 34a, 34b in the X direction (first direction) parallel to the straight line L is smaller than a length W2 of each of the movable contacts 34a, 34b in the Y direction (second direction) perpendicular to the X direction (W1<W2).

In the planar view seen along the Z direction, the length W1 in the X direction is a length between an intersection of the straight line L and the peripheral edge of each of the movable contacts 34a, 34b, and the length W2 in the Y direction is a length between an intersection of a straight line (not illustrated), passing through the contact point P and orthogonal to the straight line L, and the peripheral edge of each of the movable contacts 34a, 34b.

Further, a distance D1 between the linear portions 341 of the movable contacts 34a, 34b, namely, the maximum distance D1 in the X direction between the movable contacts 34a, 34b is smaller than the maximum distance D2 in the X direction between the fixed contacts 33a, 33b (D1<D2).

In the planar view seen along the Z direction, the maximum distance D1 in the X direction between the movable contacts 34a, 34b is the distance between the intersections closer to the permanent magnets 55 among the intersections of the straight line L and the peripheral edges of the movable contacts 34a, 34b, and the maximum distance D2 in the X direction between the fixed contacts 33a, 33b is the distance between the intersections closer to the permanent magnets 55 among the intersections of the straight line L and the peripheral edges of the fixed contacts 33a, 33b.

A description will be given here of the electromagnetic repulsive forces which are generated when the fixed contacts 33a, 33b and the movable contacts 34a, 34b come into contact with each other at the contact points P and currents flow between the fixed contacts 33a, 33b and the movable contacts 34a, 34b.

As illustrated in FIG. 5, it is assumed that the fixed contacts 33a, 33b and the movable contacts 34a, 34b come into contact with each other at the contact points P and currents flow in the direction indicated by the arrows A1 to A6 between the fixed contacts 33a, 33b and the movable contacts 34a, 34b. In this case, since the directions of the currents flowing through the fixed contacts 33a, 33b (arrows A2 and A3) and the directions of the currents flowing through the movable contacts 34a, 34b (arrows A4 and A5) are opposite to each other, electromagnetic repulsive forces acts in the direction indicated by arrows E1, E2 between the fixed contacts 33a, 33b and the movable contacts 34a, 34b, namely, in the direction in which the fixed contacts 33a, 33b and the movable contacts 34a, 34b are separated from each other.

The electromagnetic repulsive forces generated between the fixed contacts 33a, 33b and the movable contacts 34a, 34b increase proportionally to portions S where the fixed contacts 33a, 33b and the movable contacts 34a, 34b overlap in the planar view seen along the Z direction. That is, the electromagnetic repulsive forces can be reduced by reducing the portions S where the fixed contacts 33a, 33b and the movable contacts 34a, 34b overlap in the planar view seen along the Z direction.

As described above, in the electromagnetic relay 100, in the planar view seen along the Z direction (the contact or separation direction of the movable contacts 34a, 34b), the maximum distance D1 in the X direction (first direction) parallel to the straight line L between the pair of movable contacts 34a, 34b is smaller than the maximum distance D2 in the X direction (first direction) between the pair of fixed contacts 33a, 33b. Therefore, the portions S where the fixed contacts 33a, 33b and the movable contacts 34a, 34b overlap in the planar view seen along the Z direction decrease, and the electromagnetic repulsive forces generated between the fixed contacts 33a, 33b and the movable contacts 34a, 34b are reduced.

As illustrated in FIG. 4, both ends of the movable touch piece 32 in the X direction are formed along the linear portions 341 of the movable contacts 34a, 34b, and a length D3 (illustrated in FIG. 3) of the movable touch piece 32 in the X direction is smaller than the maximum distance D2 in the X direction between the fixed contacts 33a, 33b (D3<D2). As a result, the electromagnetic repulsive force generated between the fixed contacts 33a, 33b and the movable touch piece 32 is reduced, so that the electromagnetic repulsive force generated between the fixed contacts 33a, 33b and the movable contacts 34a, 34b can be reduced effectively.

Further, in the planar view seen along the Z direction, the movable contacts 34a, 34b are located in the fixed contacts 33a, 33b. Moreover, the peripheral edges of the fixed contacts 33a, 33b are chamfered. It is thereby possible to reliably reduce the portions where the fixed contacts 33a, 33b and the movable contacts 34a, 34b overlap in the planar view seen along the Z direction.

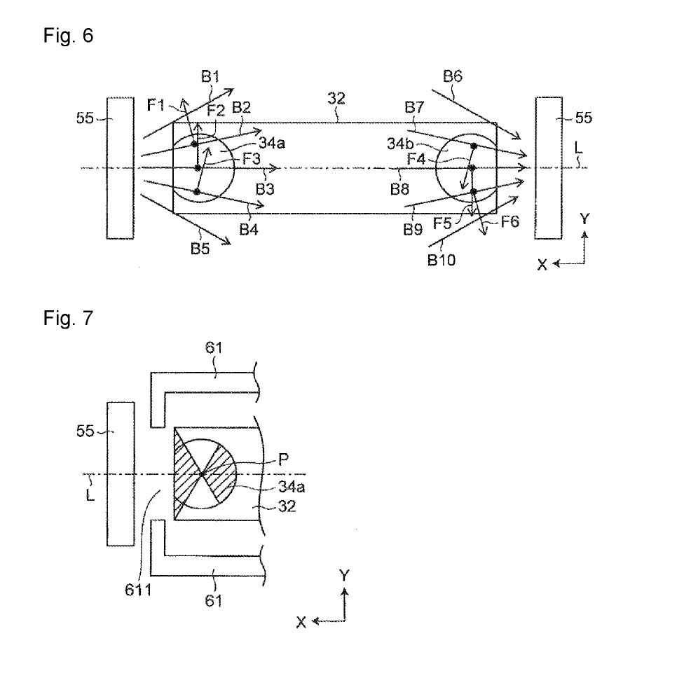

Subsequently, referring to FIGS. 6 and 7, arcs generated between the fixed contacts 33a, 33b and the movable contacts 34a, 34b will be described.

In FIG. 6, it is assumed that a current flows between the fixed contacts 33a, 33b and the movable contacts 34a, 34b on the left side in the X direction, from the upper side to the lower side in the Z direction (from the front side to the back side in FIG. 6), and a current flows between the fixed contacts 33a, 33b and the movable contacts 34a, 34b on the right side in the X direction, from the lower side to the upper side in the Z direction (from the back side to the front side in FIG. 6).

As illustrated in FIG. 6, magnetic fluxes extending as indicated by arrows B1 to B10 are generated between the pair of permanent magnets 55, 55. As a result, the arcs generated between the fixed contacts 33a, 33b and the movable contacts 34a, 34b are attracted toward the arc shielding member 61 under the Lorentz force acting in the direction indicated by the arrows F1 to F6.

At this time, assuming that portions of the fixed contacts 33a, 33b and the movable contacts 34a, 34b where the arcs are attracted (a portion except for the hatched portion in FIG. 7) are cut, the arcs generated at the contact points P cannot be attracted, and the arcs stay near the contact points P, which leads to deterioration in the fixed contacts 33a, 33b and the movable contacts 34a, 34b, such as the melting of the contact points P. The deterioration in the fixed contacts 33a, 33b and the movable contacts 34a, 34b causes welding at the contact points P between the fixed contacts 33a, 33b and the movable contacts 34a, 34b, or change at the interval between the fixed contacts 33a, 33b and the movable contacts 34a, 34b, thereby resulting in performance degradation of the electromagnetic relay 100.

Therefore, in the electromagnetic relay 100, the length W1 of each of the movable contacts 34a, 34b in the X direction (first direction) is smaller than the length W2 of each of the movable contacts 34a, 34b in the Y direction (second direction) perpendicular to the X direction (first direction). That is, the lengths W1 in the X direction (first direction), in which the arcs generated between the fixed contacts 33a, 33b and the movable contacts 34a, 34b are not attracted by the permanent magnets 55, 55, are made smaller than the lengths W2 in the Y direction (second direction), so that the portions S where the fixed contacts 33a, 33b and the movable contacts 34a, 34b overlap in the planar view seen along the Z direction are reduced. As a result, the electromagnetic repulsive forces generated between the fixed contacts 33a, 33b and the movable contacts 34a, 34b are reduced while preventing deterioration in the fixed contacts 33a, 33b and the movable contacts 34a, 34b due to the arcs, and the contact reliability between the fixed contacts 33a, 33b and the movable contacts 34a, 34b is ensured.

### Other Embodiments

The movable touch piece 32 and the movable contacts 34a, 34b are not limited to the above embodiments, and may be any movable touch piece and movable contacts so long as being capable of reducing electromagnetic repulsive forces generated between the fixed contacts 33a, 33b and the movable contacts 34a, 34b while attracting arcs in the Y direction (second direction) to prevent deterioration in the fixed contacts 33a, 33b and the movable contacts 34a, 34b.

As described above, in the electromagnetic relay 100, the Lorentz force of F1 to F6 illustrated in FIG. 6 acts on the arc. Therefore, as illustrated in FIG. 7, even if a part of the movable touch piece 32 and the movable contacts 34a, 34b in the X direction (indicated by hatching) is cut, the contact reliability between the fixed contacts 33a, 33b and the movable contacts 34a, 34b is not affected significantly. That is, by cutting all or part of the hatched portions illustrated in FIG. 7 from the movable touch piece 32 and the movable contacts 34a, 34b, it is possible to reduce the portions where the movable touch piece 32 and the movable contacts 34a, 34b overlap with the fixed contacts 33a, 33b, while preventing deterioration in the fixed contacts 33a, 33b and the movable contacts 34a, 34b due to arcs.

Note that the directions in which the arcs generated between the fixed contacts 33a, 33b and the movable contacts 34a, 34b are attracted change in accordance with the currents flowing between the fixed contacts 33a, 33b and the movable contacts 34a, 34b and the strengths of the magnetic fluxes of the permanent magnets. Therefore, the shaded range illustrated in FIG. 7 is determined by the currents flowing between the fixed contacts 33a, 33b and the movable contacts 34a, 34b and the strengths of the magnetic fluxes of the permanent magnets.

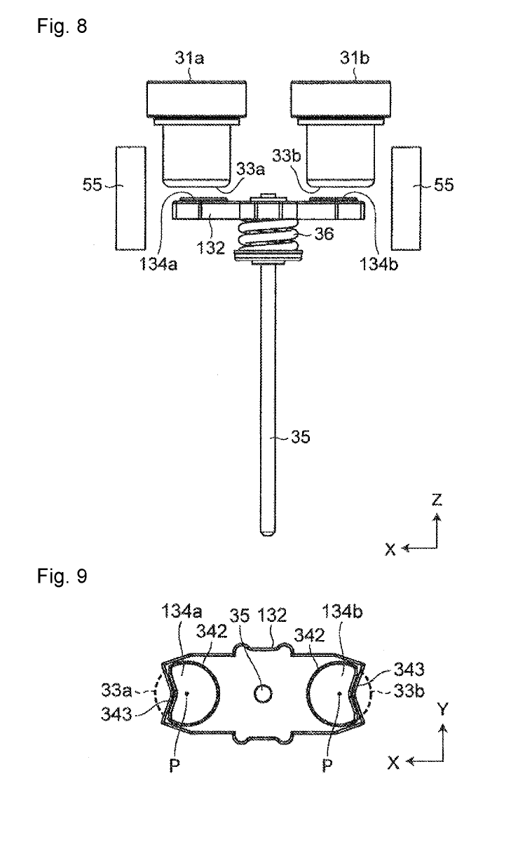

For example, the movable touch piece and the movable contacts may be a movable touch piece 132 and movable contacts 134a, 134b illustrated in FIGS. 8 and 9. In the planar view seen along the Z direction, each of the movable contacts 134a, 134b has a shape made up of a linear bent portion 343 and an arcuate portion 342 in a portion facing the adjacent permanent magnet 55, the linear bent portion 343 having a substantially center portion bent in a direction toward the contact point P, the arcuate portion 342 extending from the bent portion 343 toward the movable shaft 35. Both ends of the movable touch piece 132 in the X direction are formed along the bent portions 343 of the movable contacts 134a, 134b.

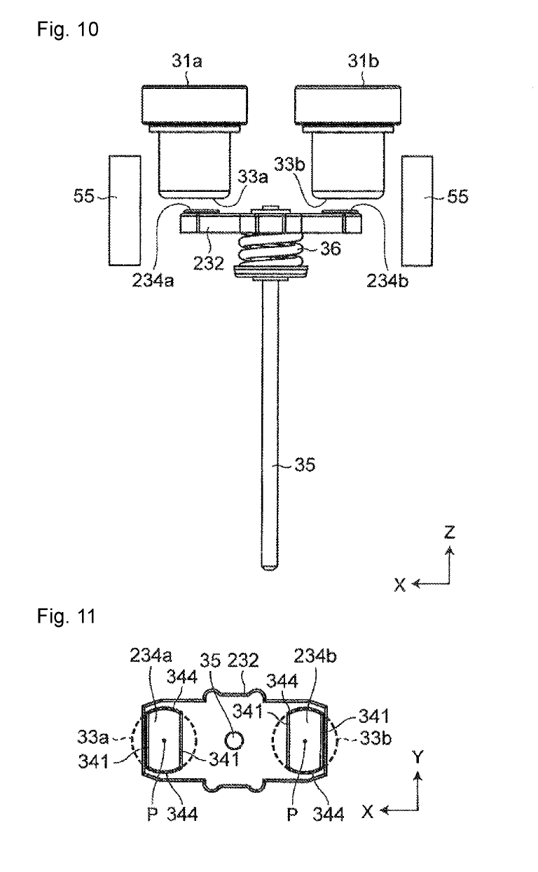

Further, the movable touch piece and the movable contacts may be a movable touch piece 232 and movable contacts 234a, 234b illustrated in FIGS. 10 and 11. In the planar view seen along the Z direction, each of the movable contacts 234a, 234b has a shape made up of linear portions 341 arranged parallel to the Y direction and an arcuate portion 344 connecting both ends of the linear portions 341 in the Y direction. Both ends of the movable touch piece 232 in the X direction are formed along the linear portions 341 of the movable contacts 234a, 234b.

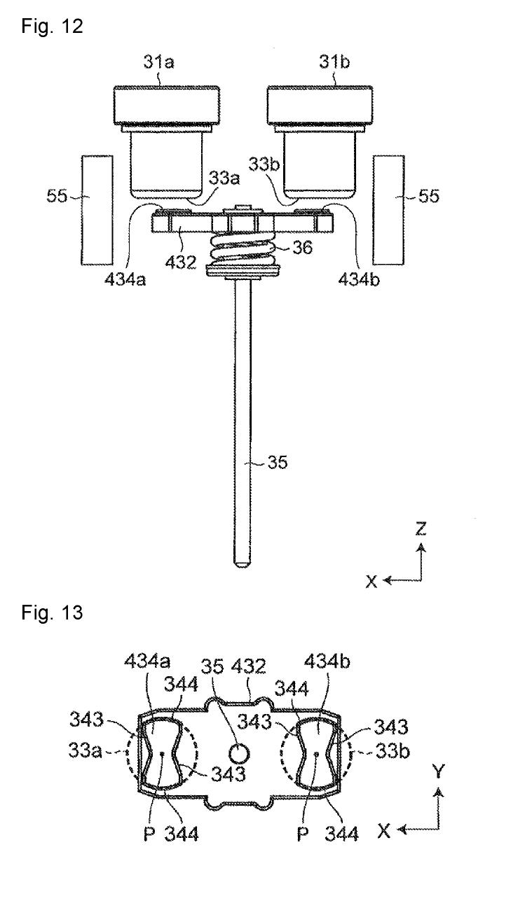

Moreover, the movable touch piece and the movable contacts may be a movable touch piece 432 and movable contacts 434a, 434b illustrated in FIGS. 12 and 13. In the planar view seen along the Z direction, each of the movable contacts 434a, 434b has a shape made up of bent portions 343 arranged symmetrically with respect to the contact point P at intervals in the X direction, and an arcuate portion 344 connecting both ends of the bent portions 343 in the Y direction. The movable touch piece 432 is formed in a straight shape with both ends in the X direction extending in the Y direction.

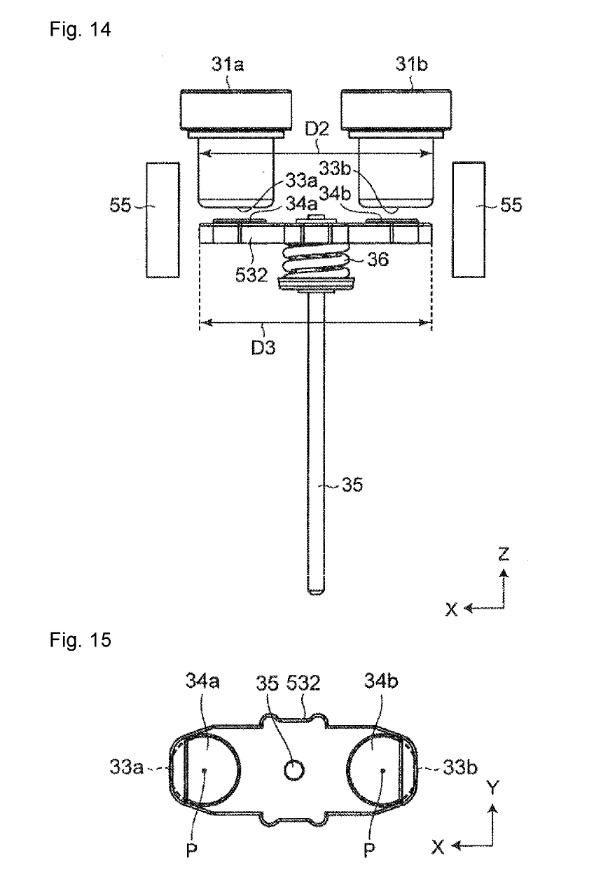

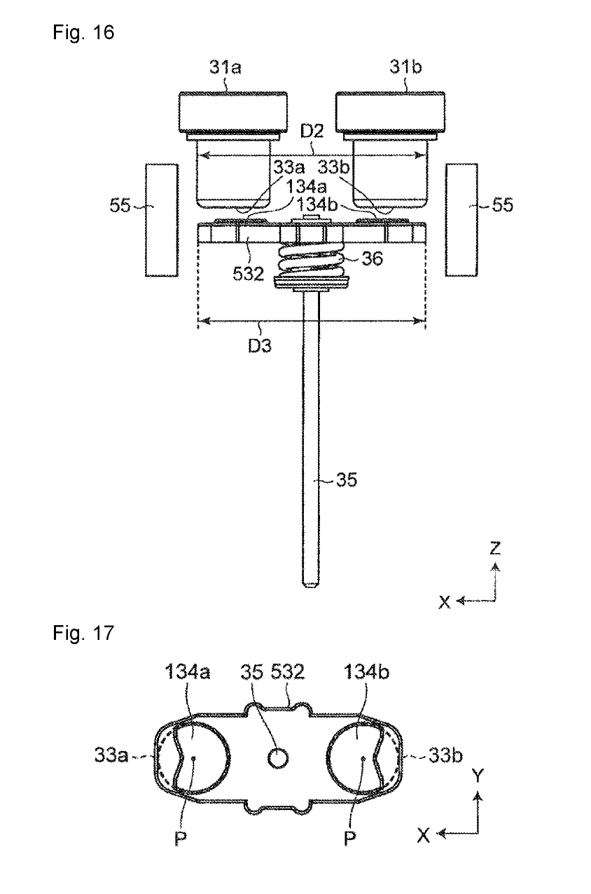

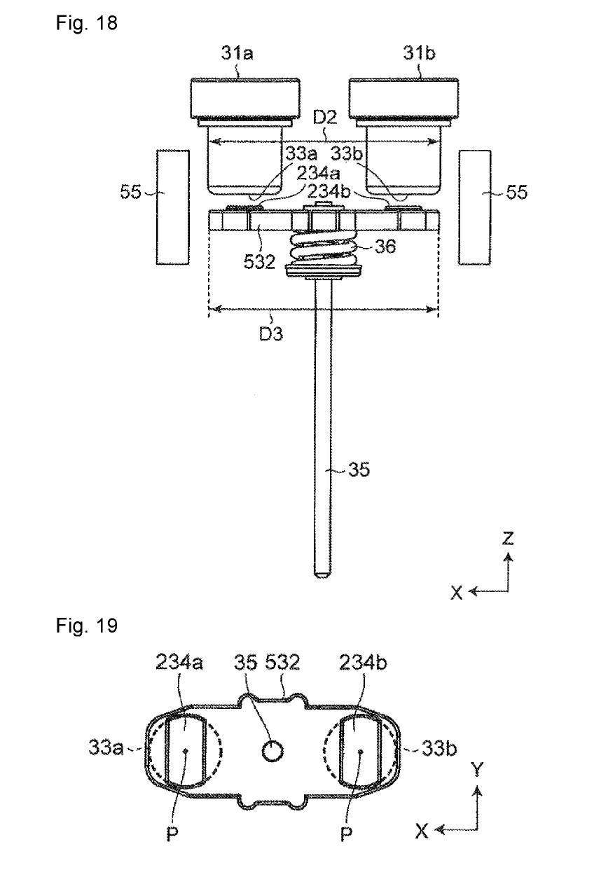

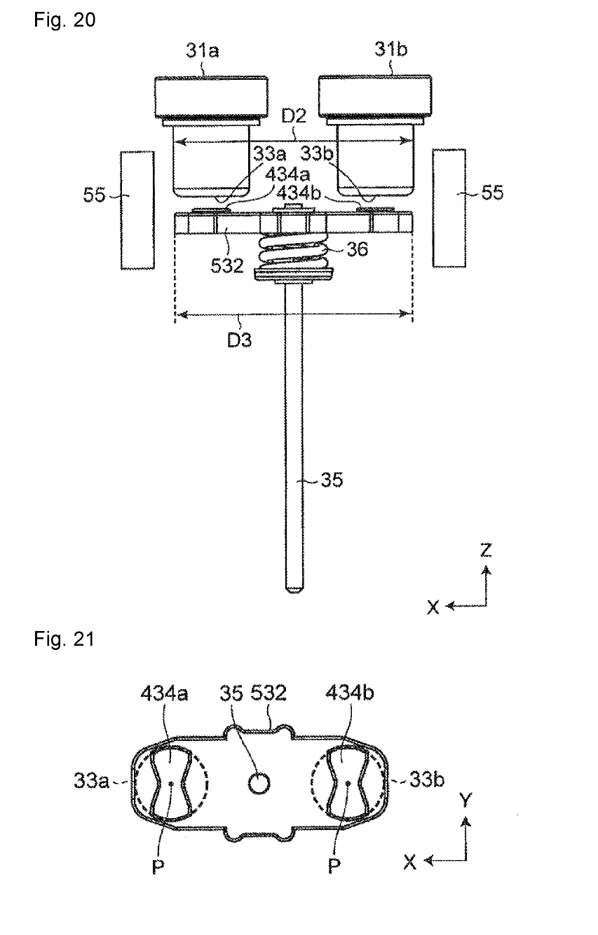

In one or more of the above embodiments, the length D3 of the movable touch piece 32 in the X direction has been made smaller than the maximum distance D2 between the pair of fixed contacts 33a, 33b. However, the present invention is not limited thereto. For example, as illustrated in FIGS. 14 to 21, the movable touch piece may be a movable touch piece 532 with the length D3 in the X direction being equal to or greater than the maximum distance D2 between the pair of fixed contacts 33a, 33b.

The shape of each of the fixed terminals 31a, 31b is not limited to the substantially cylindrical shape and can be appropriately changed in accordance with the design of the electromagnetic relay or the like.

The chamfering of the peripheral edges of the fixed contacts 33a, 33b may be omitted.

In the planar view seen along the Z direction the shape of each the fixed contacts 33a, 33b is not limited to the substantially circular shape and can be appropriately changed in accordance with the design of the electromagnetic relay or the like.

The pair of fixed contacts 33a, 33b and the pair of movable contacts 34a, 34b may be arranged asymmetrically with respect to the movable shaft 35.

The pair of permanent magnets 55, 55 may have different poles or the same poles.

An auxiliary yoke may be provided between the fixed contacts 33a, 33b. The auxiliary yoke may be made up, for example, of a U-shaped yoke and a plate-shaped yoke, the U-shaped yoke having a substantially U-shape in cross section and being provided in the movable touch piece, the plate-shaped yoke being fixed so as to face the U-shaped yoke and forming a gap between the plate-shaped yoke and the U-shaped yoke. In addition, in the auxiliary yoke, when a current flows through the movable touch piece, magnetic fluxes passing through the U-shaped yoke and the plate-shaped yoke are formed, and a magnetic attraction force acts between the U-shaped yoke and the plate-shaped yoke. Since this magnetic attraction force and the electromagnetic repulsive force generated between the fixed contact and the movable contact act in mutually canceling directions, the contact reliability between the fixed contact and the movable contact can be ensured.

The straight line L passing through the pair of fixed contacts 33a, 33b and the pair of movable contacts 34a, 34b may be any straight line so long as passing through the pair of fixed contacts 33a, 33b and the pair of movable contacts 34a, 34b. The straight line L is not limited to the straight line passing through the contact points P of the movable contacts 34a, 34b. For example, a straight line passing through the pair of fixed contacts and the pair of movable contacts may be a straight line passing through the centers of the fixed contacts and the movable contacts.

Naturally, the constituents described in the above embodiments may be appropriately combined or may be appropriately selected, replaced, or deleted.

Various embodiments of the present invention will be described below.

An electromagnetic relay of one or more embodiments of the present invention includes: a pair of fixed contacts; a pair of movable contacts that respectively face the pair of fixed contacts and are arranged so as to be able to respectively come into contact with and be separated from the pair of fixed contacts; a movable touch piece configured to electrically connect the pair of movable contacts; and a pair of permanent magnets that are arranged on a straight line passing through the pair of fixed contacts and the pair of movable contacts in a planar view seen along a contact or separation direction in which each of the movable contacts comes into contact with or is separated from each of the fixed contacts, face each other, and are arranged so as to sandwich the pair of fixed contacts and the pair of movable contacts. A maximum distance between the pair of movable contacts in a first direction parallel to the straight line is smaller than a maximum distance between the pair of fixed contacts in the first direction in the planar view seen along the contact or separation direction.

According to the electromagnetic relay of one or more embodiments of the present invention, in the planar view seen along the direction in which each of the movable contacts comes into contact with or is separated from each of the fixed contacts, the maximum distance between the pair of movable contacts in the first direction is smaller than the maximum distance between the pair of fixed contacts in the first direction. As a result, the overlapping portion between the fixed contact and the movable contact in the planar view seen along the contact or separation direction becomes smaller, thereby enabling reduction in electromagnetic repulsive force which is generated when a current flows between the fixed contact and the movable contact.

In an electromagnetic relay of one or more embodiments of the present invention, a length of the movable contact in the first direction is smaller than a length of the movable contact in a second direction perpendicular to the first direction in the planar view seen along the contact or separation direction.

According to the electromagnetic relay of one or more embodiments of the present invention, the length W1 in the first direction, in which an arc generated between the fixed contact and the movable contact is not attracted by the permanent magnet, is made smaller than the length in the second direction, so that a portion S where the fixed contact and the movable contact overlap in the planar view seen along the contact or separation direction is reduced. As a result, the electromagnetic repulsive force generated between the fixed contact and the movable contact is reduced while preventing deterioration in the fixed contact and the movable contact due to the arc, and the contact reliability between the fixed contact and the movable contact is ensured.

In an electromagnetic relay of one or more embodiments of the present invention, a length of the movable touch piece in the first direction is smaller than a maximum distance between the pair of fixed contacts in the first direction in the planar view seen along the contact or separation direction.

According to the electromagnetic relay of one or more embodiments of the present invention, the overlapping portion between the fixed contact and the movable contact in the planar view seen along the contact or separation direction becomes smaller, thereby enabling reduction in electromagnetic repulsive force which is generated between the fixed contact and the movable contact.

In an electromagnetic relay of one or more embodiments of the present invention, the movable contact is located in the fixed contact in the planar view seen along the contact or separation direction.

According to the electromagnetic relay of one or more embodiments of the present invention, it is possible to reliably reduce a portion where the fixed contact and the movable contact overlap in the planar view seen along the contact or separation direction.

In an electromagnetic relay of one or more embodiments of the present invention, the peripheral edge of the fixed contact is chamfered.

According to the electromagnetic relay of one or more embodiments of the present invention, it is possible to reliably reduce a portion where the fixed contact and the movable contact overlap in the planar view seen along the contact or separation direction.

By appropriately combining freely selected embodiments or modifications of the above variety of embodiments and modifications, it is possible to achieve the respective effects of those combined. It is possible to combine embodiments, combine examples, or combine an embodiment and an example, and also possible to combine features in different embodiments or examples.

While the present invention has been fully described in connection with embodiments with reference to the accompanying drawings, various modifications or corrections will be apparent to those skilled in the art. It should be appreciated that such modifications and corrections are included within the scope of the present invention unless they depart from the scope of the present invention specified by the appended claims.

The electromagnetic relay is not limited to the above embodiments, but can be applied to other electromagnetic relays.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### DESCRIPTION OF SYMBOLS

1 housing
10 case
11 terminal groove
12 latching hole
20 cover
21 partition wall
22 terminal hole
30 contact mechanism portion
31a, 31b fixed terminal
32, 132, 232, 432, 532 movable touch piece
33a, 33b fixed contact
34a, 34b, 134a, 134b,
234a, 234b, 434a, 434b movable contact
341 linear portion
342, 344 arcuate portion
343 bent portion
35 movable shaft
36 coil spring
40 electromagnet portion
41 spool
411 body portion
412 guard portion
42 coil
43 coil terminal
44 second yoke
51 flange
52 ceramic plate
521 terminal hole
53 first yoke
531 opening
54 bottomed cylindrical body
55 permanent magnet
56 magnet holder
57 fixed iron core
58 movable iron core
59 return spring
61 arc shielding member
611 space
100 electromagnetic relay
A1 to A6 current
B1 to 10 magnetic flux
D1 maximum distance in first direction (X direction) between movable contacts
D2 maximum distance in first direction (X direction) between fixed contacts
D3 length of movable touch piece in first direction (X direction)
E1, E2 electromagnetic repulsive force
F1 to F6 Lorentz force
L straight line connecting contact points
P contact point
S portion where fixed contact and movable contact overlap in planar view seen along Z direction
W1 length of movable contact in first direction (X direction)
W2 length of movable contact in second direction (Y direction)

1. An electromagnetic relay comprising:
a pair of fixed contacts;
a pair of movable contacts that respectively face the pair of fixed contacts and are structured to respectively come into contact with and be separated from the pair of fixed contacts;
a movable touch piece configured to electrically connect the pair of movable contacts; and
a pair of permanent magnets that are arranged on a straight line passing through the pair of fixed contacts and the pair of movable contacts in a planar view seen along a contact-separation direction in which each of the movable contacts comes into contact with or is separated from each of the fixed contacts,
wherein the pair of permanent magnets face each other,
wherein the pair of permanent magnets are arranged so as to sandwich the pair of fixed contacts and the pair of movable contacts,
wherein a maximum distance between the pair of movable contacts in a first direction parallel to the straight line is smaller than a maximum distance between the pair of fixed contacts in the first direction in the planar view seen along the contact-separation direction.

2. The electromagnetic relay according to claim 1, wherein a length of the movable contact in the first direction is smaller than a length of the movable contact in a second direction perpendicular to the first direction in the planar view seen along the contact-separation direction.

3. The electromagnetic relay according to claim 1, wherein a length of the movable touch piece in the first direction is smaller than a maximum distance between the pair of fixed contacts in the first direction in the planar view seen along the contact-separation direction.

4. The electromagnetic relay according to claim 1, wherein the movable contact is located in the fixed contact in the planar view seen along the contact-separation direction.

5. The electromagnetic relay according to claim 1, wherein a peripheral edge of the fixed contact is chamfered.

6. The electromagnetic relay according to claim 2, wherein a length of the movable touch piece in the first direction is smaller than a maximum distance between the pair of fixed contacts in the first direction in the planar view seen along the contact-separation direction.

7. The electromagnetic relay according to claim 2, wherein the movable contact is located in the fixed contact in the planar view seen along the contact-separation direction.

8. The electromagnetic relay according to claim 3, wherein the movable contact is located in the fixed contact in the planar view seen along the contact-separation direction.

9. The electromagnetic relay according to claim 2, wherein a peripheral edge of the fixed contact is chamfered.

10. The electromagnetic relay according to claim 3, wherein a peripheral edge of the fixed contact is chamfered.

11. The electromagnetic relay according to claim 4, wherein a peripheral edge of the fixed contact is chamfered.
